(19) United States
(12) Patent Application Publication
(10) Pub. No.: US 2011/0145515 A1
(43) Pub. Date: Jun. 16, 2011

(54) Method for modifying a shared data queue and processor configured to implement same

(75) Inventor: Benjamin Serebrin, Sunnyvale, CA (US)

(73) Assignee: Advanced Micro Devices, Inc., Sunnyvale, CA (US)

(21) Appl. No.: 12/653,466

(22) Filed: Dec. 14, 2009

(51) Int. Cl. G06F 12/02

(52) U.S. Cl. 711/150; 711/E12.013

(57) ABSTRACT

According to one exemplary embodiment, a method for modifying a shared data queue accessible by a plurality of processors comprises receiving an instruction from one of the processors to produce a modification to the shared data queue, running a microcode program in response to the instruction, to attempt to produce the modification, and generating a final datum to signify whether the modification to the shared data queue has occurred. In one embodiment, the modification comprises enqueuing data, and running the microcode program includes checking writability of a write pointer of the shared data queue, checking writability of a data field designated by the write pointer, locking the write pointer and checking the old value of its lock bit with atomicity, writing the data to the data field and incrementing the write pointer by the size of the data, and unlocking the write pointer.

### BACKGROUND OF THE INVENTION

1. Field of the Invention

The present invention is generally in the field of electrical circuits and systems. More specifically, the present invention is in the field of data management in memory systems and devices.

2. Background Art

Application programs utilizing multiple processors to access a common memory are increasingly common. Often, under those circumstances, more than one processor will attempt to access the same data queue concurrently. For example, one or more data producer processors may contend to enqueue data to a data queue, and one or more data consumer processors may seek to dequeue data from the same data queue. A significant challenge arising in this environment is synchronizing access to the shared data queue to assure rapid and efficient enqueuing and dequeuing of data by the various processors contending for access to the queue, while also ensuring the integrity of the data residing in the queue.

A conventional method for synchronizing access to a shared data queue relies upon sophisticated software algorithms developed for that purpose. However, because of the numerous competing imperatives to which any synchronizing algorithm must be obedient, such solutions tend to be extremely complicated, and require substantial processing overhead for their implementation. For example, in order to avoid the problem of deadlock, synchronizing algorithms are now typically non-blocking in their operation. However, data queues managed by block free algorithms are susceptible to the “ABA problem,” in which the content of a data register is changed from “A” to “B,” and then back to “A,” in between read operations, unless some mechanism, such as an additional in-memory counter, is used to track the activity related to the queue. As a result, conventional software algorithms for synchronizing access to a data queue tend to burden the queue and to impair the performance of the memory system in which it is used.

Thus, there is a need in the art for a solution enabling concurrent access to a shared data queue that lowers the processing overhead required for synchronization while preserving data integrity.

### SUMMARY OF THE EMBODIMENTS OF THE INVENTION

A method for modifying a shared data queue and processor configured to implement same, substantially as shown in and/or described in connection with at least one of the figures, as set forth more completely in the claims. In one embodiment, the method comprises receiving an instruction from the processor to produce a modification to the shared data queue, running a microcode program in response to the instruction to attempt to produce the modification, and generating a final datum to signify whether the modification to the shared data queue has occurred. In various embodiments, the method can modify a shared data queue by enqueuing data to the shared data queue, e.g., writing data to the queue, and/or by dequeuing data from the shared data queue, e.g., reading data from the queue.

### BRIEF DESCRIPTION OF THE DRAWINGS

FIG. 1 is a block diagram of a computing environment in which multiple processors content to access a shared data queue, in accordance with one embodiment of the present invention.

FIG. 2 is a flowchart presenting a method for enqueuing data to a shared data queue, in accordance with one embodiment of the present invention.

FIG. 3 is a flowchart presenting a method for dequeuing data from a shared data queue, in accordance with one embodiment of the present invention.

### DETAILED DESCRIPTION OF EMBODIMENTS OF THE INVENTION

Present embodiments of the invention are directed to a method for modifying a shared data queue and processor configured to implement same. The following description contains specific information pertaining to the implementation of embodiments of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

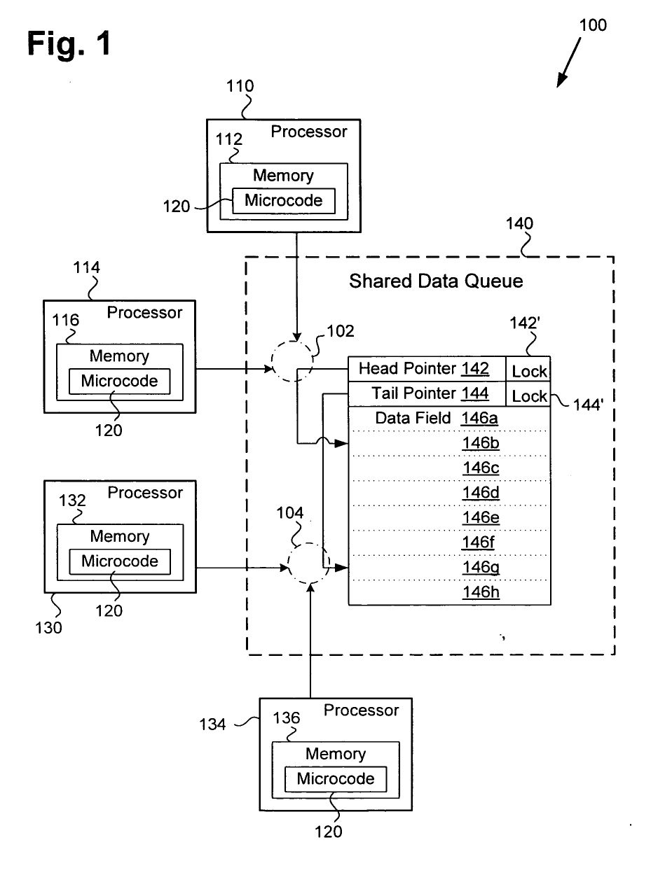

FIG. 1 is a block diagram of computing environment 100 in which multiple processors contend to access a shared data queue, in accordance with one embodiment of the present invention. Computing environment 100 comprises a plurality of processors including processor 110, processor 114, processor 130, and processor 134, all seeking to access shared data queue 140. Shared data queue 140, which may be a first-in-first-out (FIFO) queue, for example, is shown to comprise head pointer 142 including lock bit 142′, tail pointer 144 including lock bit 144′, and data fields 146a, 146b, 146c, 146d, 146e, 146f, 146g, and 146h (hereinafter: data fields 146a-h).

It is noted that computing environment 100 may contain additional data queues in addition to shared data queue 140, which are not shown in FIG. 1 for purposes of brevity and simplicity of illustration. In addition, the linear array structure characterizing the data fields of shared data queue 140 is shown for conceptual clarity, and is not intended to be limiting. In other embodiments, depending on the data structures implemented in the relevant computing environment, shared data queue 140 may be characterized as comprising data nodes for example, rather than data fields 146a-h, and those data nodes may be represented by a configuration markedly different from that represented by FIG. 1, such as by a circular ring arrangement of nodes.

It is further noted that although the embodiment of FIG. 1 shows four separate processors, in other embodiments there may be as few as two processors accessing shared data queue 140, or more than the four processors shown to populate computing environment 100. Moreover, in some embodiments, two or more of processors 110, 114, 130, and 134 may share a common die, and/or be co-packaged, such as in a multi-processor chip, for example.

Processor 110, which may be a scheduling processor such as a central processing unit (CPU) or graphics processing unit (GPU) of a personal computer (PC), for example, is shown to comprise memory unit 112 and microcode program 120 stored in memory unit 112. As will be more fully described subsequently, microcode program 120 is configured to attempt to produce a modification to shared data queue 140, and to generate a final datum signifying whether the modification to shared data queue 140 has occurred. As a result, processor 110 may enqueue or dequeue data on shared data queue 140 without interfering with similar operations performed by sharing processors 114, 130, and 134.

Similarly, each of sharing processors 114, 130, and 134, which may also comprise PC CPU or GPU processors, for example, comprises a memory unit and the microcode program for attempting to produce a modification to shared data queue 140 stored therein. Thus, processor 114 includes memory unit 116 storing microcode program 120, processor 130 includes memory unit 132 storing microcode program 120, and processor 134 includes memory unit 136 storing microcode program 120.

According to the embodiment of FIG. 1, processors 110 and 114 are contending to access head pointer 142 in order to modify shared data queue 140 by enqueuing data, as shown by enqueue contention region 102. In addition, processors 130 and 134 are contending to access tail pointer 144 in order to modify shared data queue 140 by dequeuing data, as shown be dequeue contention region 104. It is noted that although enqueuing of data is generally understood to correspond to performing a write operation to memory, and that dequeuing of data is understood to correspond to a read operation from memory, there is less agreement upon whether an enqueue operation is performed at the head or at tail of the shared data queue.

For the purposes of the present embodiment, a convention in which enqueuing is facilitated by head pointer 142 at the head of shared data queue 140, and in which dequeuing is facilitated by tail pointer 144 at the tail of shared data queue 140 will be observed. However, in other embodiments, that arrangement could be switched, so that enqueuing is facilitated by tail pointer 144 at the tail of shared data queue 140 and dequeuing is facilitated by head pointer 142 at the head of shared data queue 140. More generally, however, Applicant adopts a usage in which enqueuing is facilitated by a write pointer and dequeuing is facilitated by a read pointer.

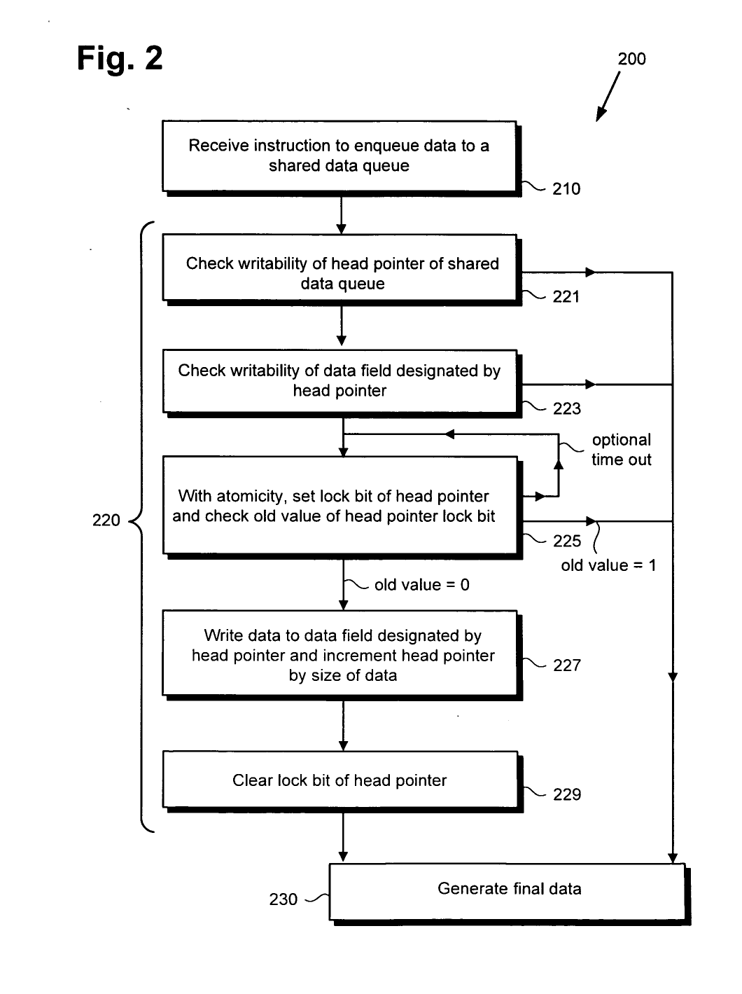

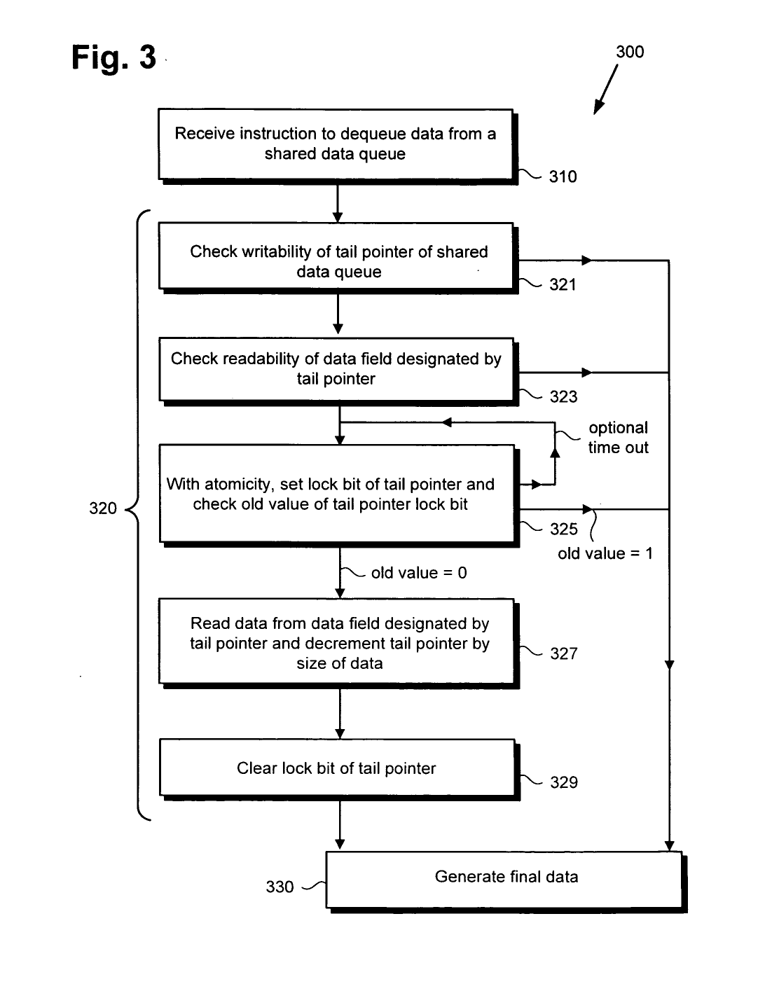

The process of modifying shared data queue 140 will now be described in conjunction with FIGS. 2 and 3, which present flowcharts 200 and 300 describing respective methods for enqueuing data to shared data queue 140 and dequeuing data from shared data queue 140, according to example embodiments of the present invention. Certain details and features have been left out of flowcharts 200 and 300 that are apparent to a person of ordinary skill in the art. For example, a given step may consist of one or more substeps or may involve specialized equipment or materials, as known in the art. While steps 210 through 230 indicated in flowchart 200 and steps 310 through 330 indicated in flowchart 300 are sufficient to describe some embodiments of the present method, other embodiments may utilize steps different from those shown in flowcharts 200 and 300, or may include more, or fewer steps.

Starting with step 210 in FIG. 2 and continuing to refer to computing environment 100, in FIG. 1, step 210 of flowchart 200 comprises receiving an instruction to enqueue data to shared data queue 140. More generally, step 210 corresponds to receipt of an instruction to produce a modification to shared data queue 140, by either enqueuing or dequeuing data, for example. According to the enqueuing method of flowchart 200, the instruction requests an enqueue, or write, operation. In a PC computing environment, for example, step 210 may comprise microcode program 120 receiving an x86 instruction from either of processors 110 or 114 seeking to enqueue data to shared data queue 140. The enqueue instruction received in step 210 would typically include information in its argument. For example, in addition to the address of the head or write pointer for the shared data queue, and the data to be enqueued, the instruction may specify the size of the data being enqueued.

The method of flowchart 200 continues with step 220, which comprises running microcode program 120 including substeps 221, 223, 225, 227, and 229 (hereinafter: substeps 221-229), which will be individually described in greater detail below. The microcode program then executes some or all of substeps 221-229 in an attempt to produce the modification to shared data queue 140 requested in step 210. Step 220 may be performed using the same respective processor 110, 114, 130, or 134 which issued the enqueue instruction in step 210.

The present inventor has realized that implementation of a microcode program to effectuate a modification to a shared data queue obviates many of the problems associated with use of a higher level software code to synchronize access to the shared data queue in the conventional approach. For example, because conventional queue algorithms are designed specifically for non-occurrence of deadlock, those queue algorithms are non-blocking. By contrast, microcode is much less susceptible to interrupts than are higher level software codes, so that non-occurrence of deadlock can be assured through the use of microcode programming even where the microcode program itself temporarily locks an operation on the shared data queue, for example, the enqueue or dequeue operations.

In conventional non-blocking queue algorithms, the ABA problem is addressed through various remedial techniques. A typical approach is to add an additional in-memory counter to the queue pointers that track queuing and dequeuing events. However, because a microcode program may temporarily lock queuing or dequeuing, no such additional counters are required for the present approach utilizing microcode. Consequently, the present inventor is able to disclose a novel approach to producing modifications to a shared data queue that, amongst other potential features, both avoids the problems arising in the context of conventional solutions, and alleviates the burden to the queue imposed by implementation of those conventional solutions.

Moving on to step 230 of flowchart 200 before discussing substeps 221-229 in greater detail, step 230 of flowchart 200 comprises generating a final datum to signify whether the requested modification to shared data queue 140 has occurred. Thus, step 230 may correspond to termination of microcode program 120 and the attendant generation of a carry flag or page fault indicator to signify success or failure of the requested operation.

Turning now to substeps 221-229 of the microcode program run in step 220 of flowchart 200 and continuing to refer to FIG. 1, substep 221 of flowchart 200 comprises checking the writability of head pointer 142. Checking the writability of head pointer 142 in substep 221 may include comparing head pointer 142 and tail pointer 144 as well. Depending on the implementation utilized, instances in which the head pointer and tail pointer either point to the same data field, or point to adjacent data fields, can indicate that the queue is full or empty, which would render respective enqueue or dequeue operations impracticable.

Step 220 of flowchart 200 continues with substep 223 comprising checking the writability of data field 146b designated by head pointer 142, if head pointer 142 is writable. Together, substeps 221 and 223 assure that either the subsequent microcode substeps 225-229 will proceed without a fault occurring, or that they will not be initiated at all. For example, if substep 221 reveals that head pointer 142 is not writable, step 220 terminates, causing a page fault data to be generated in step 230 of flowchart 200. Similarly, if substep 223 reveals that data field 146b designated by head pointer 142 is not writable, step 220 terminates and causes page fault data to be generated in step 230. However, if writability is detected in both of substeps 221 and 223, then a no fault condition is guaranteed during the execution of substeps 225-229. In other words, the microcode program is configured to assure that a no fault condition is present before beginning to affirmatively modify shared data queue 140.

Continuing with substep 225 of step 220, the actions of substep 225 are performed with atomicity, as known in the art, and comprise setting lock bit 142′ of head pointer 142 and checking the old value of lock bit 142′. If the old value of lock bit 142′ is one, i.e., the bit is locked, that might indicate that an enqueue to the shared data queue was being performed by another processor. In some embodiments, an old value of one for lock bit 142′ in substep 225 may cause step 220 to terminate, resulting in a carry flag zero to be generated in step 230, signifying that the requested modification has not occurred. In other embodiments, as shown in FIG. 2, step 220 may include an optional time out, after which substep 225 could be repeated. Both the duration of the time out period and the number of iterations of a time out process before termination of step 220 are parameters that may vary, either by design, or according to constraints imposed by the computing environment in which the method of flowchart 200 is performed.

However, if the old value of lock bit 142′ is zero, i.e., the bit is not locked, substep 225 has set its new value to one (locked), thereby preventing another processor from enqueuing data prior to completion of step 220. Subsequently, the data to be enqueued to shared data queue 140 is written to data field 146b designated by head pointer 142, and the position of head pointer 142 is incremented by the size of the data. As previously described, the size of the data being enqueued will typically be information included in the argument of the enqueue instruction received in step 210.

Once enqueuing of the data is performed in substep 227, lock bit 142′ is cleared in substep 229, unlocking head pointer 142 for use by another processor seeking to enqueue data to shared data queue 140. Success of substeps 225-229 results in generation of a carry flag 1 in step 230, signifying that the enqueue requested in step 210 has occurred. It is noted that although the present description associates incrementing of the position of head pointer 142 with enqueuing of the data in substep 227, in other embodiments, incrementing of the position of head pointer 142 and clearing of lock bit 142′ may be performed concurrently.

Turning to FIG. 3, flowchart 300 shows an example method for dequeuing data from a shared data queue that proceeds analogously to the method of flowchart 200, in FIG. 2. Step 310, like step 210, comprises receiving an instruction from one of a plurality of processors to produce a modification to shared data queue 140. In the embodiment shown in FIG. 3, the requested modification is one of dequeuing or reading data from shared data queue 140, and may be received from one of processors 130 and 134 seeking to perform such an operation.

Similarly, steps 320 and 330 of flowchart 300 proceed respectively by running microcode program 120, this time to attempt to produce the requested dequeue operation, and generating a final datum to signify whether the dequeue operation has occurred. Substeps 321-329 of step 320 are also analogous, for a read operation, to steps 221-229 shown in FIG. 2 for a write operation. Substep 321 comprises checking the writability of the read pointer, e.g., tail pointer 144, while substep 323 this time comprises checking the readability of data field 146g designated by tail pointer 144. A negative result for either check performed in substeps 321 and 323 results in termination of step 320 and generation of a page fault data in step 330. As was described for the enqueuing process of flowchart 200, in FIG. 2, checking the writability of tail pointer 144 in substep 321 of flowchart 300 may include comparing tail pointer 144 and head pointer 142. As previously explained, depending on the implementation utilized, instances in which the tail pointer and head pointer either point to the same data field, or point to adjacent data fields, can indicate that the queue is full or empty, which would render respective enqueue or dequeue operations impracticable.

Positive results for both of substeps 321 and 323 guarantee a no fault condition for performance of substeps 325-329. Substep 325 comprises setting lock bit 144′ of tail pointer 144 and checking the old value of lock bit 144′, and performing those actions with atomicity. As was the case for the enqueue process, the dequeue operation can either terminate and generate a failure carry flag, or time out for one or more iterations of substep 325, if the old value of lock bit 144′ indicates that it is locked.

If the old value of lock bit 144′ indicates that the lock bit was not locked, substep 325 sets lock bit 144′ to prevent other processors from simultaneously dequeuing data from shared data queue 140. Substep 327 comprises reading the data from data field 146g designated by tail pointer 144 and decrementing tail pointer 144 by the size of the data dequeued. Then, lock bit 144′ is cleared, in substep 329, unlocking tail pointer 144 for use in facilitating another enqueue operation, and a carry flag signifying that the requested dequeue operation has occurred is generated in step 330. It is noted that although the present description associates decrementing of the position of tail pointer 144 with reading the data in substep 327, in other embodiments, decrementing of the position of tail pointer 144 and clearing of lock bit 144′ may be performed concurrently.

Although the present application has thus far characterized microcode program 120 as residing in memory units 112, 116, 132, and 136, in other embodiments instructions for performing the methods of flowcharts 200 and 300, including respective microcode program substeps 221-229 and 321-329, can reside on a computer-readable medium compatible with computing environment 100. The expression “computer-readable medium,” as used in the present application, refers to any medium that stores instructions for use by processors 110, 114, 130, or 134.

Thus, a computer-readable medium may correspond to various types of media, such as volatile media, non-volatile media, and transmission media, for example. Volatile media may include dynamic memory, such as dynamic random-access memory (RAM), while non-volatile memory may include optical, magnetic, or electrostatic storage devices. Transmission media may include coaxial cable, copper wire, or fiber optics, for example, or may take the form of acoustic or electromagnetic waves, such as those generated through radio frequency (RF) and infrared (IR) communications. Common forms of computer-readable media include, for example, a RAM, programmable read-only memory (PROM), erasable PROM (EPROM), and FLASH memory.

Thus, the present application discloses methods for modifying a shared data queue and processors configured to utilize those methods to concurrently access the shared data queue. By using a microcode program to perform a requested queue modification, the present inventive concepts provide a solution that is both resistant to computing interruptions and quick to execute. Consequently, the method may temporarily lock certain operations on the data queue to assure data integrity, while avoiding the problem of deadlock faced by conventional blocking algorithms. Moreover, because data integrity is assured by the temporary locking of the present method, the present novel method also enables avoidance of the ABA problem, without the data queue burdens and performance impairment imposed by non-blocking queue algorithms in the conventional art.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

1. A method for modifying a shared data queue accessible by a plurality of processors, said method comprising:
receiving an instruction from one of said plurality of processors to produce a modification to said shared data queue;
running a microcode program in response to said instruction to attempt to produce said modification to said shared data queue; and
generating a final datum to signify whether said modification to said shared data queue has occurred.

2. The method of claim 1, wherein said modification to said shared data queue comprises enqueuing data to said shared data queue.

3. The method of claim 2, wherein said microcode program comprises instructions for:
locking a write pointer of said shared data queue and checking the old value of a lock bit of said write pointer if said write pointer and a data field designated by said write pointer are writable, said locking and said checking performed with atomicity;
writing said data to said data field and incrementing said write pointer by the size of said data; and
unlocking said write pointer.

4. The method of claim 1, wherein said modification to said shared data queue comprises dequeuing data from said shared data queue.

5. The method of claim 4, wherein said microcode program comprises instructions for:
locking a read pointer of said data queue and checking the old value of a lock bit of said read pointer if said read pointer is writable and a data field designated by said read pointer is readable, said locking and said checking performed with atomicity;
reading said data from said data field and incrementing said read pointer by the size of said data; and
unlocking said read pointer.

6. The method of claim 1, wherein at least one of said plurality of processors comprises a central processing unit (CPU) of a personal computer (PC).

7. The method of claim 1, wherein at least one of said plurality of processors comprises a graphics processing unit (GPU) of a PC.

8. The method of claim 1, wherein at least two of said plurality of processors are co-packaged.

9. A scheduling processor configured to use a shared data queue accessible by a plurality of sharing processors, said scheduling processor comprising:
a memory unit;
a microcode program stored in said memory unit;
said microcode program configured to attempt to produce a modification to said shared data queue, and to generate a final datum to signify whether said modification to said shared data queue has occurred.

10. The scheduling processor of claim 9, wherein said scheduling processor comprises one of a central processing unit (CPU) of a personal computer (PC) and a graphics processing unit (GPU) of a PC.

11. The scheduling processor of claim 9, wherein said scheduling processor is co-packaged with at least one other of said plurality of sharing processors.

12. The scheduling processor of claim 9, wherein said modification to said shared data queue comprises enqueuing data to said shared data queue.

13. The scheduling processor of claim 12, wherein said microcode program comprises instructions for:
locking a write pointer of said shared data queue and checking the old value of a lock bit of said write pointer if said write pointer and a data field designated by said write pointer are writable, said locking and said checking performed with atomicity;
writing said data to said data field and incrementing said write pointer by the size of said data; and
unlocking said write pointer.

14. The scheduling processor of claim 9, wherein said modification to said shared data queue comprises dequeuing data from said shared data queue.

15. The scheduling processor of claim 14, wherein said microcode program comprises instructions for:
locking a read pointer of said shared data queue and checking the old value of a lock bit of said read pointer if said read pointer is writable and a data field designated by said read pointer is readable, said locking and said checking performed with atomicity;
reading said data from said data field and incrementing said read pointer by the size of said data; and
unlocking said read pointer.

16. A computer-readable medium having stored thereon instructions for modifying a shared data queue accessible by a plurality of processors, which when executed by a computer processor perform a method comprising:
receiving an instruction from one of said plurality of processors to produce a modification to said shared data queue;
running a microcode program stored on said computer-readable medium in response to said instruction, to attempt to produce said modification to said shared data queue; and
generating a final datum to signify whether said modification to said shared data queue has occurred.

17. The computer readable medium of claim 16, wherein said modification to said shared data queue comprises enqueuing data to said shared data queue.

18. The computer readable medium of claim 17, wherein said microcode program comprises instructions for:
locking a write pointer of said shared data queue and checking the old value of a lock bit of said write pointer if said write pointer and a data field designated by said write pointer are writable, said locking and said checking performed with atomicity;
writing said data to said data field and incrementing said write pointer by the size of said data; and
unlocking said write pointer.

19. The computer readable medium of claim 16, wherein said modification to said shared data queue comprises dequeuing data from said shared data queue.

20. The computer readable medium of claim 19, wherein said microcode program comprises instructions for:
locking a read pointer of said shared data queue and checking the old value of a lock bit of said read pointer if said read pointer is writable and a data field designated by said read pointer is readable, said locking and said checking performed with atomicity;
reading said data from said data field and incrementing said read pointer by the size of said data; and
unlocking said read pointer.
